(19) United States
(12) Patent Application Publication
(10) Pub. No.: US 2008/0110650 A1
(43) Pub. Date: May 15, 2008

(54) Machine, hydraulic system and method for providing hydraulic power

(76) Inventors: Kevin L. Martin, Washburn, IL (US); Brian Howson, Peoria, IL (US)

Correspondence Address: CATERPILLAR c/o LIELL & MCNEIL ATTORNEYS PC, P.O. BOX 2417, 511 SOUTH MADISON STREET, BLOOMINGTON, IN, 47402-2417, US

(21) Appl. No.: 11/588,960

(22) Filed: Oct. 27, 2006

(51) Int. Cl. A01B 63/00

(52) U.S. Cl. 172/667

(57) ABSTRACT

A machine includes a frame having a longitudinal axis and including front and back sets of ground engaging elements. A coupler is suspended below the frame and configured for moving between first and second sideshift positions. A hydraulic system for the machine includes a hydraulically actuated device mounted to the coupler and a hydraulic circuit for providing hydraulic power to the device throughout the range of motion of the coupler. A circuit includes a flexible segment and a rigid support segment configured to support the flexible segment above a work surface. The rigid support segment is mounted to a pivot device and pivotable between an extended position and a stowed position corresponding respectively to the sideshift positions of the coupler. A method of providing hydraulic power to a hydraulically actuated device includes connecting a hydraulic circuit with a hydraulically actuated device mounted to an implement coupler of a machine. The method also includes controlling positioning of fluid lines of the hydraulic circuit during moving the coupler via a rigid support segment of the hydraulic circuit that pivots between a stowed position and extended position corresponding to the sideshift positions of the coupler.

### TECHNICAL FIELD

The present disclosure relates generally to machines and machine hydraulic systems having movable hydraulically actuated devices, and relates more particularly to a machine and method wherein components of a hydraulic circuit for providing hydraulic power to a device are supported by a pivoting rigid support segment of the hydraulic circuit during sideshift movement of a coupler to which the device is mounted.

### BACKGROUND

Construction machines, in particular earthworking machines, are indispensable to modern society. Agriculture, mining, building and road construction and a host of other endeavors rely upon the transport, placement and treatment of soil, rock and other materials with construction machines. While a great many successful and important machines and machine configurations have been developed over the years, specialization of certain classes of machines has lead to their use primarily within relatively narrow, albeit important, applications. Motor graders and the like are one example of a class of machines well-suited to certain tasks, but heretofore somewhat limited in their ability to operate beyond applications for which the machines are primarily engineered. Motor graders have for many years proven to be the most effective and efficient means for grading, distributing and leveling material in a variety of environments. While motor graders are also sometimes used in snow removal and related tasks, they tend to sit idle more often than desired. In other words, despite the tremendous success of the conventional motor grader design in performing certain types of work, there tend to be limitations to the suitability of motor graders for uses beyond certain basic tasks. The desirability of a means for adapting motor graders and the like to different operating environments, and for use in unconventional applications, has been recognized for some time.

One means for increasing the range of tasks which may be performed by motor graders has been through improvements to the means and methods for attaching work implements such as blades. It is typical for a motor grader to have a factory-installed implement system, which is typically disassembled only for service or replacement of the implement. Swapping implements on motor graders in the field has until recently been rare or unknown. Certain newer designs, however, contemplate switching the factory-installed implement for other devices in the field without substantial effort, rendering the motor grader amenable to different tasks, or providing greater flexibility even when used in conventional work. While increasing the number and type of implements that can be utilized by a motor grader promises to substantially broaden the use of these relatively large, and relatively expensive machines, new implement types and the hardware enabling such added flexibility introduce new challenges.

Many motor graders include an implement system that is highly maneuverable, permitting a conventional motor grader blade to be moved side-to-side, up and down, and the implement angle of attack and rotational position of the blade adjusted, for example. Where certain implements, such as hydraulically actuated implements, are to be mounted to and used by a motor grader, the substantial degree of flexibility in movement of the implement creates a challenge for supplying hydraulic power throughout the range of motion of the implement, as well as hydraulically actuated coupling hardware, where used. There is thus a need for an improved means of providing hydraulic power to implements configured for use with motor graders and the like.

The problems posed by hydraulically actuated devices and the like having a need for hydraulic power throughout a range of motion is a problem previously recognized in other technical areas. U.S. Pat. No. 4,384,619 to Schuck provides a hose tensioning device for a side shift plow assembly. Schuck states that a hose tensioning device can permit a relatively large amount of hydraulic hose for an implement control cylinder to be fed out or retracted for accommodating movement of a side shifting implement. In particular, Schuck utilizes a spring biased arm which engages with a flexible hose group carrying hydraulic fluid. Schuck is similar to other known hose tensioning devices, typically utilizing a tension spring or the like or a retraction reel to permit a large amount of hydraulic line to be positioned out of the way during moving or stowing a hydraulically actuated device. While Schuck and similar devices may provide improvements over simply allowing hydraulic lines to sag and potentially drag on the ground or be impinged upon by other components, feeding out and drawing in a relatively large amount of hydraulic line is inherently unwieldy and complex in design.

The present disclosure is directed to one or more of the problems or shortcomings set forth above.

### SUMMARY OF THE INVENTION

In one aspect, the present disclosure provides a machine that includes a frame having a longitudinal axis and a front set of ground engaging elements and at least one back set of ground engaging elements. The machine further includes a coupler suspended below the frame and positioned between the front and back sets of ground engaging elements. The coupler is configured for mounting an implement thereon and movable between a first position and a second position defining a range of motion of the coupler transverse to the axis. The machine further includes a hydraulic system having a hydraulic circuit for providing hydraulic power to a hydraulically actuated device movable with the coupler throughout the range of motion of the coupler transverse to the axis, the hydraulic circuit including a flexible segment and a rigid support segment configured to support the flexible segment above a work surface. The rigid support segment is pivotable between an extended position and a stowed position corresponding to the first and second positions of the coupler, respectively.

In another aspect, the present disclosure provides a method of providing hydraulic power to a hydraulically actuated device of a machine having a frame with front and back sets of ground engaging elements. The method includes connecting a hydraulic circuit of the machine with a hydraulically actuated device movable via an implement coupler of the machine suspended below the frame and positioned between the front and back sets of ground engaging elements, the coupler being movable transverse to a longitudinal axis of the machine between a first position and a second position defining a range of motion of the coupler transverse to the longitudinal axis. The method further includes controlling positioning of fluid lines of the hydraulic circuit during moving the coupler between the first and second positions at least in part by pivoting a rigid support segment of the hydraulic circuit between a stowed position and an extended position corresponding to the first and second positions of the coupler, respectively, and supporting a flexible segment of the hydraulic circuit with the rigid support segment during pivoting the rigid support segment.

In still another aspect, the present disclosure provides a hydraulic system for an implement system of a machine having a frame with front and back sets of ground engaging elements. The hydraulic system includes a first hydraulic circuit segment including a supply passage and a return passage, and a second hydraulic circuit segment connected with the first hydraulic circuit segment, and also including a supply passage and a return passage fluidly connected with the supply passage and return passage, respectively, of the first hydraulic circuit segment. The first and second hydraulic circuit segments are configured for providing hydraulic power to a hydraulically actuated device movable with an implement coupler of the implement system throughout a range of motion of the coupler transverse to a longitudinal axis of the machine. A rigid support is coupled with the first hydraulic circuit segment and extends in parallel therewith, the rigid support being configured to support the second hydraulic circuit segment above a work surface during moving of the coupler between a first position and a second position defining the range of motion of the coupler. The rigid support is pivotable, between an extended position and a stowed position corresponding to the first and second positions of the coupler, respectively.

### BRIEF DESCRIPTION OF THE DRAWINGS

FIG. 1 is a side diagrammatic view of a machine according to one embodiment;

FIG. 2 is a pictorial view of an implement assembly having a hydraulic system according to one embodiment; and

FIG. 3 is a pictorial view of a portion of a hydraulic circuit suitable for use with the machine and implement system of FIGS. 1 and 2, according to one embodiment.

### DETAILED DESCRIPTION

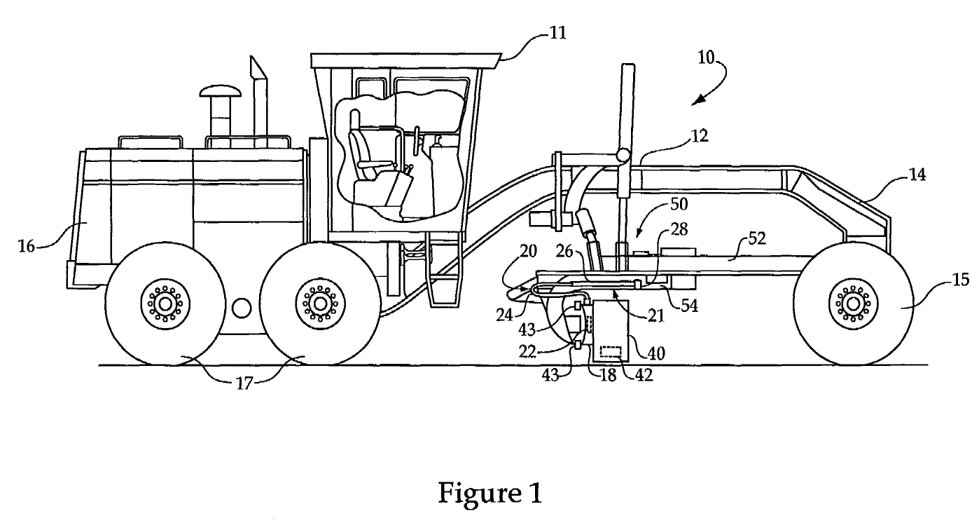

Referring to FIG. 1, there is shown a machine 10 according to one embodiment of the present disclosure. Machine 10 includes a frame 12, having a front frame unit 14 with a set of ground engaging elements 15 such as wheels coupled therewith, and a back frame unit 16 having at least one set of ground engaging elements 17 coupled therewith. Machine 10 is shown in the context of a motor grader machine wherein back frame unit 16 is configured to articulate relative to front frame unit 14. The present disclosure is not thereby limited, however, and rather than an articulated machine, may comprise a machine having a non-articulating frame. Further, while wheels are used to illustrate ground engaging elements 15 and 17, tracks, etc. might be used. Machine 10 may include a hydraulic system 20 configured to provide hydraulic power to at least one hydraulically actuated device 22 and 42 throughout a range of motion of a coupler 18 to which device 22, 42 is mounted and movable therewith.

An implement assembly 50 may be suspended below frame 12, and may include a drawbar 52 and circle 54, together comprising a drawbar and circle assembly. Coupler 18 may be a part of, and supported by implement assembly 50, and positioned between front and back ground engaging elements 15 and 17. In one embodiment, coupler 18 may include rails 43 enabling coupler 18 to slide back and forth transverse to a longitudinal axis of machine 10 between a first sideshift position and a second sideshift position, approximately in and out of the page in the FIG. 1 illustration. In the context of a motor grader machine, coupler 18 may have multiple degrees of freedom of movement, as further described herein. Coupler 18 may further be configured for mounting an implement 40 thereon, having hydraulically actuated device 42. Device 42 may include a hydraulic motor or linear actuator, for example, configured to power implement 40, which may comprise an angled broom, a mower, a cold planer, one of numerous types of non-hydraulically actuated grader blades, or some other implement. Thus, while implement 18 may include a hydraulically actuated device, it does not have to, and might include no moving parts, although in all embodiments implement 18 will itself be movable with coupler 18. Hydraulically actuated device 22 may comprise a hydraulic actuator which is configured for engaging implement 40 with coupler 18 via movable elements, also further described herein. In other embodiments, coupler 18 might not include a hydraulically actuated device. Accordingly, references herein to a hydraulically actuated device movable with coupler 18 should be understood to refer to either or both of devices 22 and 42, as hydraulic system 20 is configured to provide power to either or both of devices 22 and 42 throughout a range of motion of coupler 18, between its respective sideshift positions.

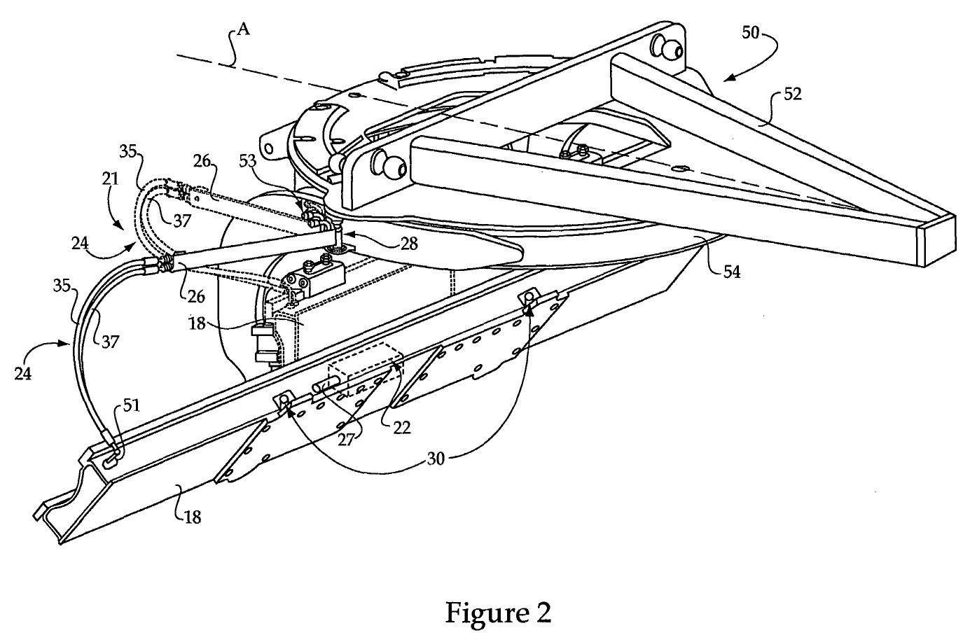

Referring also to FIG. 2, illustrating implement assembly 50, coupler 18 is shown approximately at a first sideshift position, and at a forward tilt position, in solid lines, and shown approximately at a second sideshift position, oriented at a neutral tilt position, in phantom. Coupler 18 may be movable between its respective sideshift positions via actuators (not shown) of implement system 50, and may be tilted between the two positions shown in FIG. 2 via other actuators (also not shown) of implement system 50. Coupler 18 may also swing side to side via rotation of drawbar 52 about a longitudinal axis A of machine 10, and may be rotated via rotation of circle 54. In one embodiment, coupler 18 may comprise a quick coupler apparatus of the type taught in copending and commonly assigned patent application Ser. No. 11/443,066.

In FIG. 2, hydraulic system 20 is also illustrated in two different configurations/positions, corresponding to the first and second sideshift positions of coupler 18. Moving of components of hydraulic system 20 between its respective positions/configurations shown in FIG. 2 will enable supplying of hydraulic power to device 22 and/or device 42 throughout a range of motion of coupler 18 relative to a longitudinal axis A of machine 10, the range of motion being defined by the first and second sideshift positions of coupler 18, approximately as shown in FIG. 2. As alluded to above, device 22 may comprise an implement coupling mechanism including a hydraulic actuator 27 coupled with hydraulically actuated mounting elements 30 such as pins, configured for engaging with mating features on an implement such as implement 40.

Hydraulic system 20 may comprise a hydraulic circuit 21 having a first segment 26 and a second segment 24, a first fluid line 35 that includes therein a fluid passage and a second fluid line 37 that also includes therein a fluid passage. Each of fluid lines 35 and 37 may extend from a first set of hydraulic connectors 53 mounted to circle 54, for example, to a second set of hydraulic connectors 51 which are mounted to coupler 18, for example. In embodiments where coupler 18 does not itself include a hydraulically actuated device, fluid lines 35 and 37 might extend directly to an implement such as implement 40 having device 42. First segment 26 may consist of a rigid support segment comprising a rigid support for second segment 24, which may comprise a flexible segment. First segment 26 is configured to support second segment 24 above a work surface during moving of coupler 18 between its first and second sideshift positions, preventing sagging of hydraulic circuit 21 and potential dragging against the ground or impingement by other components of machine 10. The present disclosure is particularly well-suited to the motor grader environment, due to proximity to the ground of line 35 and 37, and the typically relatively large amount of sideshift travel, in contrast to earlier lines routing strategies in different machine environments. Even in the motor grader context, certain earlier strategies relying on a large amount of vertical hose length, or different lines routing than that shown herein, are inferior in terms of complexity and their effects on the range of motion of the implement assembly components.

First segment 26 may be mounted to a pivot device or pin joint 28 which enables pivoting of first segment between an extended position, shown in solid lines in FIG. 2, and a stowed position, shown in dashed lines in FIG. 2. While mounting of pivot device 28 to one of frame 12 and circle and drawbar assembly 52, 54, is contemplated to provide one practical implementation strategy, the present disclosure is not thereby limited. In other embodiments, the illustrated configuration might be reversed, with pivot device 28 mounted to coupler 18 or even to implement 40. The stowed and extended positions for first segment 26 correspond to the first and second sideshift positions of coupler 18, and accordingly, first segment 26 will tend to move generally in concert with coupler 18.

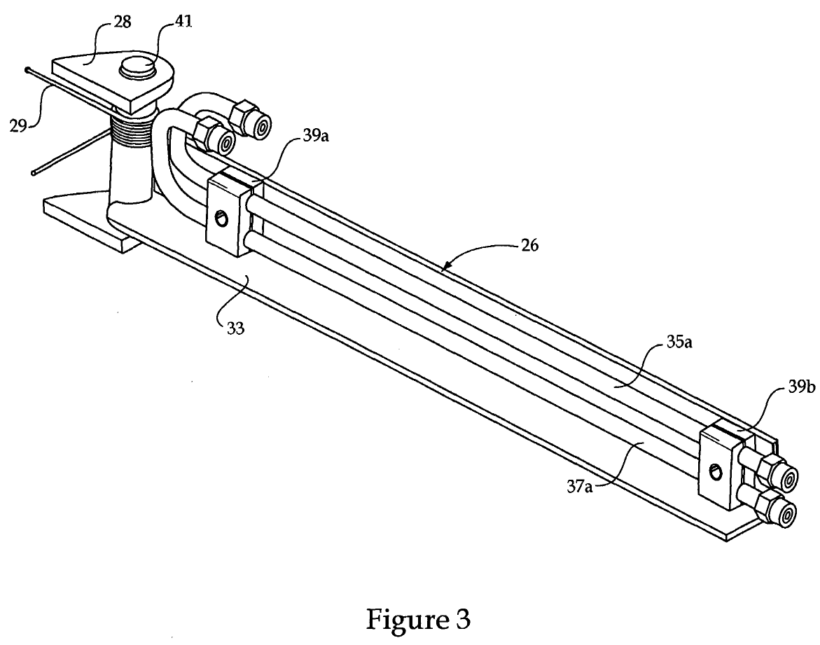

Turning to FIG. 3, there is shown first segment 26 in more detail. First segment 26 may include a rigid housing 33 extending in parallel with a portion 35a of first fluid line 35 and a portion 37a of second fluid line 37, and at least partially enclosing the respective line portions. Housing 33 may have a length similar to that of line portions 35a and 37a, but need not. Each of line portions 35a and 37a will typically be configured to fluidly connect with corresponding supply and return portions of second segment 24. In one embodiment, line portions 35a and 37a may include rigid tube members supported in housing 33 with a first support block 39a and a second support block 39b disposed proximate opposite ends of housing 33. In other embodiments, line portions 35a and 37a might consist of flexible lines mounted in or to housing 33. Pivot device 28 is also shown coupled with an end of housing 33, and includes a pivot pin 41 configured to support housing 33 and defining a pivot axis. A biasing member 29 may be provided, which is configured to bias housing 33 toward the stowed position of first segment 26, which will typically be a position such that housing 33 is oriented substantially parallel longitudinal axis A of machine 10.

Those skilled in the art will appreciate that a wide variety of configurations for housing 33, line portions 35a and 37a, pivot device 28, etc. are possible, and the present description is illustrative only. Moreover, the specific configuration chosen will depend at least in part on the machine and implement system within which a hydraulic system according to the present disclosure is implemented. While first and second segments 26 and 24 are shown as having approximately equal lengths, their respective lengths might differ in other embodiments, depending upon the range of motion through which hydraulic power is to be provided. It will generally be desirable to avoid bending flexible second segment 24 beyond a manufacturer recommended hose radius lower limit. More than one fluid supply line and one fluid return line might also be used, for example where multiple hydraulically actuated devices are provided with hydraulic power in the present context. Still further, while the use of housing 33 as a rigid support for first segment 26 is contemplated to provide a practical implementation strategy, the present disclosure is not thereby limited, and rigid supply and return lines configured to pivot via pivot device 28 might be used as a rigid support apart from a dedicated housing structure.

### INDUSTRIAL APPLICABILITY

Referring to the drawing Figures generally, when machine 10 executes certain operations, such as moving coupler 18 in directions transverse to axis A, the relative position of any hydraulically actuated devices mounted to or within coupler 18, and to or within implement 40, will change relative to the rest of machine 10. In particular, the distance between connectors 53 and 51 will tend to change as a result of sideshift movement of coupler 18 relative to the circle and drawbar assembly comprised of drawbar 52 and circle 54. Other adjustments of coupler 18 will also tend to affect this relative distance. Consequently, the distance spanned by segments 26 and 24 of hydraulic circuit 21 will also change.

The changing distance over which hydraulic power is to be supplied will be accommodated via pivoting of first segment 26 about pivot device 28. For instance, when coupler 18 is moved generally leftward and out of the page relative to the FIG. 2 illustration, first segment 26 will tend to be urged away from its stowed position parallel axis A, against the bias of biasing member 29, by pulling thereon by second segment 24. When coupler 18 is moved in an opposite direction, generally rightward and into the page relative to the FIG. 2 illustration, biasing member 29 will tend to urge first segment 26 back toward its stowed position. Because first segment 26 extends rigidly from pivot device 28, it will tend to elevate the relatively more flexible second segment 24, rather than permitting second segment 24 to sag downwardly toward a work surface and risk damage, as line slack develops in hydraulic circuit 21.

The present disclosure provides substantial advantages over known systems for playing out and retracting lines, and will provide for increased use, application and versatility of motor grader and similar machines. Rather than requiring an unwieldy spool or other expensive, bulky and complex take-up apparatus, hydraulic system 20 is configured via only a modest amount of additional hardware, and relies primarily upon the use of a simple, rigid supporting portion of the hydraulic circuit itself to control positioning of other components of the circuit. The presently disclosed strategy is also especially well-suited to the motor grader environment, though not strictly limited thereto.

The present description is for illustrative purposes only, and should not be construed to narrow the breadth of the present disclosure in any way. Thus, those skilled in the art will appreciate that various modification might be made to the presently disclosed embodiments without departing from the intended spirit and scope of the present disclosure. For instance, the present disclosure has been described in the context of an articulated machine such as a motor grader, it is not thereby limited. Embodiments are contemplated wherein other machines such as those commonly used on construction sites and known as angled broom machines, having a dedicated purpose such as sweeping pavement with a relatively large, rotating brush, might be amenable to modification according to the present disclosure. In other words, devices such as angled brooms which formerly provided only one type of use, may be applied in other work environments to perform different tasks, by modification to use different implements in the manner described herein. Other aspects, features and advantages will be apparent upon an examination of the attached drawings and appended claims.

What is claimed is:

1. A machine comprising:
a frame having a longitudinal axis, and including a front set of ground engaging elements and at least one back set of ground engaging elements;
a coupler suspended below said frame and positioned between said front and back sets of ground engaging elements, said coupler configured for mounting an implement thereon and being movable between a first position and a second position defining a range of motion of said coupler transverse to said axis; and
a hydraulic system including a hydraulic circuit for providing hydraulic power to a hydraulically actuated device movable with said coupler throughout the range of motion of said coupler transverse to said axis, said hydraulic circuit comprising a flexible segment and a rigid support segment configured to support said flexible segment above a work surface, said rigid support segment being pivotable between an extended position and a stowed position corresponding to the first and second positions of said coupler, respectively.

2. The machine of claim 1 wherein said machine comprises a motor grader machine, and wherein said frame comprises a front frame unit and a back frame unit configured to articulate relative to said front frame unit.

3. The machine of claim 2 further comprising a hydraulically actuated implement coupling mechanism mounted on said coupler, said hydraulic circuit being configured to provide hydraulic power to said implement coupling mechanism throughout the range of motion of said coupler transverse to said axis.

4. The machine of claim 2 further comprising a hydraulically actuated implement mounted to said coupler, said hydraulic circuit being configured to provide hydraulic power to said hydraulically actuated implement throughout the range of motion of said coupler transverse to said axis.

5. The machine of claim 2 further comprising a drawbar and circle assembly configured to suspend said coupler below said frame, and a pivot device mounted to one of said drawbar and circle assembly and said frame, said pivot device being configured to support said rigid support segment during pivoting.

6. The machine of claim 5 wherein said pivot device is mounted to said drawbar and circle assembly.

7. The machine of claim 6 wherein said rigid support segment includes a housing mounted to said pivot device, said housing extending in parallel with a fluid supply passage and a fluid return passage of said rigid support segment.

8. The machine of claim 7 wherein said pivot device further comprises a biasing member configured to bias said housing toward said stowed position.

9. The machine of claim 8 wherein said rigid support segment includes, a flexible supply line that includes said supply passage and a flexible return line that includes said return passage, disposed within said housing.

10. The machine of claim 8 wherein said rigid support segment includes, a rigid supply line that includes said supply passage and a rigid return line that includes said return passage.

11. A method of providing hydraulic power to a hydraulically actuated device of a machine having a frame with front and back sets of ground engaging elements comprising the steps of:
connecting a hydraulic circuit of the machine with a hydraulically actuated device movable via an implement coupler of the machine suspended below the frame and positioned between the front and back sets of ground engaging elements, the coupler being movable transverse to a longitudinal axis of the frame of the machine between a first position and a second position defining a range of motion of the coupler transverse to the longitudinal axis; and
controlling positioning of fluid lines of the hydraulic circuit during moving the coupler between the first and second positions at least in part by pivoting a rigid support segment of the hydraulic circuit between a stowed position and an extended position corresponding to the first and second positions of the coupler, respectively, and supporting a flexible segment of the hydraulic circuit with the rigid support segment during pivoting the rigid support segment.

12. The method of claim 11 further comprising a step of biasing the rigid support segment with a biasing member toward its stowed position.

13. The method of claim 12 wherein the controlling step further comprises pivoting the rigid support segment about a pivot device mounted to a drawbar and circle assembly of the machine.

14. The method of claim 13 further comprising the steps of supplying hydraulic fluid to the hydraulically actuated device via a first fluid line disposed within a housing of the rigid support segment and returning hydraulic fluid from the hydraulically actuated device via a second fluid line also disposed within the housing, wherein the controlling step further comprises pivoting the housing about the pivot device between the stowed position and the extended position of the rigid support segment.

15. The method of claim 14 wherein the hydraulically actuated device comprises a hydraulically actuated implement coupling mechanism of the coupler, and wherein the steps of supplying and receiving hydraulic fluid include supplying hydraulic fluid to, and returning hydraulic fluid from, the implement coupling mechanism.

16. The method of claim 15 wherein the machine comprises a motor grader machine including a frame with a front frame unit having a set of ground engaging elements and a back frame unit configured to articulate relative to the front frame unit and having at least one set of ground engaging elements, and wherein the connecting step comprises connecting the hydraulic circuit with a hydraulically actuated implement mounted to the coupler, the coupler and implement being suspended below the frame and disposed between the ground engaging elements of the front frame unit and the ground engaging elements of the back frame unit.

17. A hydraulic system for an implement system of a machine having a frame with front and back sets of ground engaging elements comprising:
a first hydraulic circuit segment including a supply passage and a return passage;
a second hydraulic circuit segment connected with said first hydraulic circuit segment, and also including a supply passage and a return passage fluidly connected with the supply passage and return passage, respectively, of said first hydraulic circuit segment;
said first and second hydraulic circuit segments being configured for providing hydraulic power to a hydraulically actuated device movable via a coupler of the implement system throughout a range of motion of the coupler transverse to a longitudinal axis of the machine;
a rigid support coupled with said first hydraulic circuit segment and extending in parallel therewith, said rigid support being configured to support said second hydraulic circuit segment above a work surface during moving of the coupler between a first position and a second position defining the range of motion of the coupler, said rigid support being pivotable between an extended position and a stowed position corresponding to the first and second positions of the coupler, respectively.

18. The hydraulic system of claim 17 comprising a supply line that includes said supply passages and a return line that includes said return passages, said rigid support comprising a housing having a length approximately equal to a length of said first hydraulic circuit segment, said housing being separate from said supply line and said return line, and being mounted to a pivot device configured to support said rigid support during pivoting.

19. The hydraulic system of claim 18 wherein said pivot device further comprises a biasing member configured to bias said rigid support toward its stowed position.
